(19) United States
(12) Patent Application Publication
(10) Pub. No.: US 2014/0164266 A1
(43) Pub. Date: Jun. 12, 2014

(54) MULTI-MEDIA FILE UPLOAD WORKFLOW AND TRANSACTIONS

(71) Applicant: WHP WORKFLOW SOLUTIONS, LLC, North Charleston, SC (US)

(72) Inventor: Thomas Guzik, Edina, MN (US)

(73) Assignee: WHP WORKFLOW SOLUTIONS, LLC, North Charleston, SC (US)

(21) Appl. No.: 13/708,688

(22) Filed: Dec. 7, 2012

(51) Int. Cl. G06Q 30/00; G06Q 50/26

(52) U.S. Cl. CPC G06Q 30/018; G06Q 50/26
USPC 705/317

(57) ABSTRACT

Techniques to receive, process and store multi-media files for law enforcement purposes are described. Transaction techniques and message digest techniques are used to ensure secure and guaranteed upload of multi-media files. Files are integrated with police case management databases. A workflow map, reporting, and statistics modules enable an administrator to detect network congestion, file corruption and other problems during uploading multi-media files. Various use cases, notably chain of custody applications are described using the transacted file upload techniques as a platform.

### BACKGROUND

The proliferation of multi-media capture devices has enabled law enforcement to capture video and audio of crimes and other law enforcement related events. Police officers, detectives and other law enforcement agents carry multi-media capture devices such as portable microphones and video recorders. In many cases, the multi-media capture devices are vehicle mounted. Multi-media captured devices may be integrated with cellular phones which communicate with a central storage for multi-media files or alternatively may communicate with an intermediate computer or processing device which in turn communicates with a central storage.

Ordinary multi-media upload operations typically include a simple upload of a multi-media file to a central storage. As in the ordinary case, the uploaded multi-media files are shared with other individuals. For law enforcement, those individuals may include prosecutors and defense attorneys and their staff. However, in the case of law enforcement, multi-media files are often used as evidence in cases. Therefore they are subject to legal restrictions including, but not limited to chain of custody validation, court seals, and privacy restrictions. For example, in the case of chain of custody, law enforcement tracks a piece of evidence's handling from source to court. In each leg of the chain of custody, law enforcement certifies and guarantees that the evidence has not been tampered with, providing a court the basis to rely on the evidence.

Furthermore, the proliferation of media capture devices has produced a corresponding proliferation of multi-media files. Multi-media files, in particular video files are relatively large, and may congest networks. Multi-media files risk corruption, especially in the event of network failure. In these situations, multi-media file risk loss, let alone availability as evidence.

Accordingly, there is an opportunity to enhance file upload operations to guarantee upload and integrity of the multi-media files, and to track workflow progress as multi-media files are uploaded and otherwise processed.

### BRIEF DESCRIPTION OF THE DRAWINGS

The Detailed Description is set forth with reference to the accompanying figures. In the figures, the left-most digit(s) of a reference use of the same reference numbers in different figures indicates similar or identical items.

FIG. 1 is a high level diagram illustrating an environment of multi-media file upload workflow and transactions.

FIG. 2 is a block diagram of an exemplary multi-media collection device and server in the context of multi-media file upload workflow and transactions.

FIG. 3 is a flow chart an exemplary transacted multi-media file upload operation.

FIG. 4 is a flow chart of an exemplary chain of custody verification operation enabled by multi-media file upload workflow and transactions.

### DETAILED DESCRIPTION

### Multi-Media File Upload Workflow and Law Enforcement

This disclosure describes multi-media file upload workflow and transactions. Specifically, this disclosure describes an environment enabling law enforcement grade guarantees on multi-media files as well as tracking the processing of multi-media files.

One insight described herein is that transaction monitors provide guarantees that predetermine operations are either all performed, or none are performed. Specifically, where a first operation and a second operation are to be bound in a transaction, if either of the first or second operations fail, then both operations are undone, or rolled back in the transaction parlance. In this way, the first and second operations are guaranteed to be an atomic, isolated, consistent and durable operation. Indeed, the definition of a transaction is to support these so-called “ACID” properties. Transaction monitors may be used as part of providing law enforcement grade guarantees on multi-media files.

Another insight described herein is that message digests and cyclic redundancy checks provide a technique to determine if a series of bytes have been tampered with. Message digests and cyclic redundancy checks apply a known algorithm and a cryptographic key on a file or portion of file, called a message. The result is a value significantly shorter than the message itself. Since this value changes if the message changes, message tampering may be detected with this technique. Law enforcement grade secure message digest algorithms such as MD5 are well known in the art. Accordingly, message digest techniques may also be used as part of providing law enforcement grade guarantees on multi-media files.

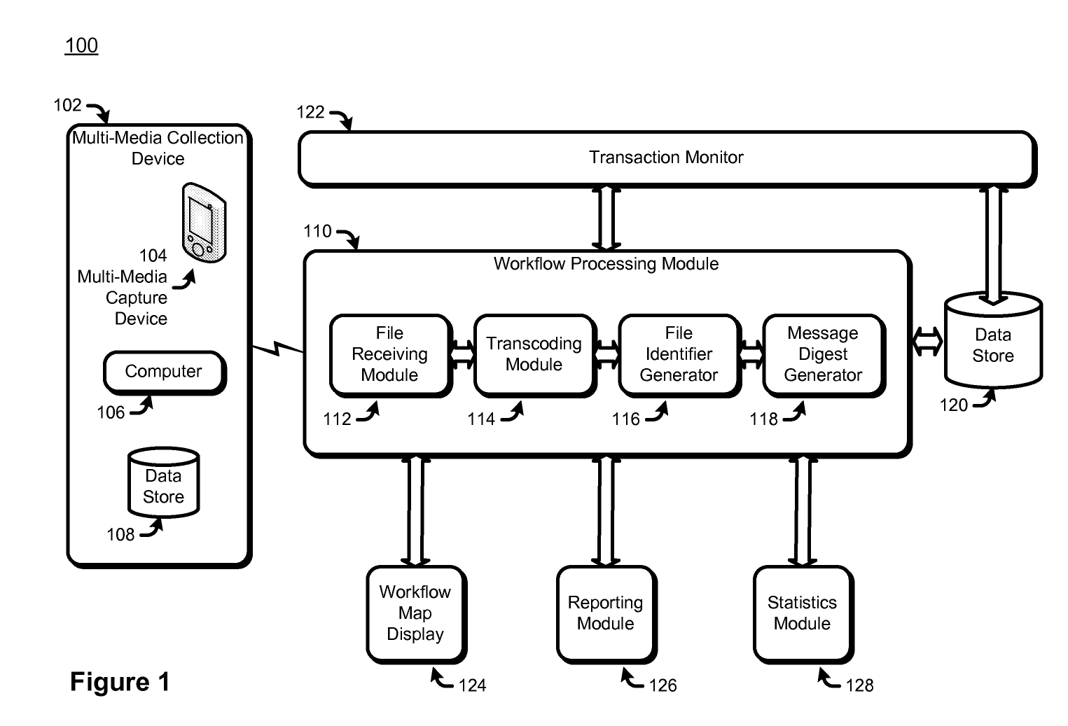

FIG. 1 is a high level diagram 100 illustrating an environment of multi-media file upload workflow and transactions as described above.

Multi-media files, such as video and audio files originate from multi-media collection devices 102. Multi-media collection devices 102 comprise a multi-media capture device 104, such as a video camera and/or an audio recorder. Often multi-media capture devices 104 are integrated within a cellular phone. Alternatively, multi-media capture devices 104 may be dedicated devices such as a digital video camera, digital still camera, or digital audio recorder. Multi-media capture devices 104 may have the capability of adding metadata such as date/time stamp of when a multi-media file was captured or geolocation information.

Multi-media capture devices 104 may connect to a computer 106 such as a laptop for post-processing. Alternatively, if the multi-media capture devices 104 are integrated within a cellular phone with sufficient processing capacity, then the cellular phone's processing capacity may constitute computer 106. At computer 106, post processing such as transcoding, or the changing of a file's format to another format, may be performed. Additionally commentary and other metadata may be generated at computer 106.

Multi-media collection devices 102 also include a data store 108. While data store 108 may be onboard memory on a multi-media capture device 104, it may also be the hard disk of computer 106 or alternatively a separate removable thumb drive or memory stick.

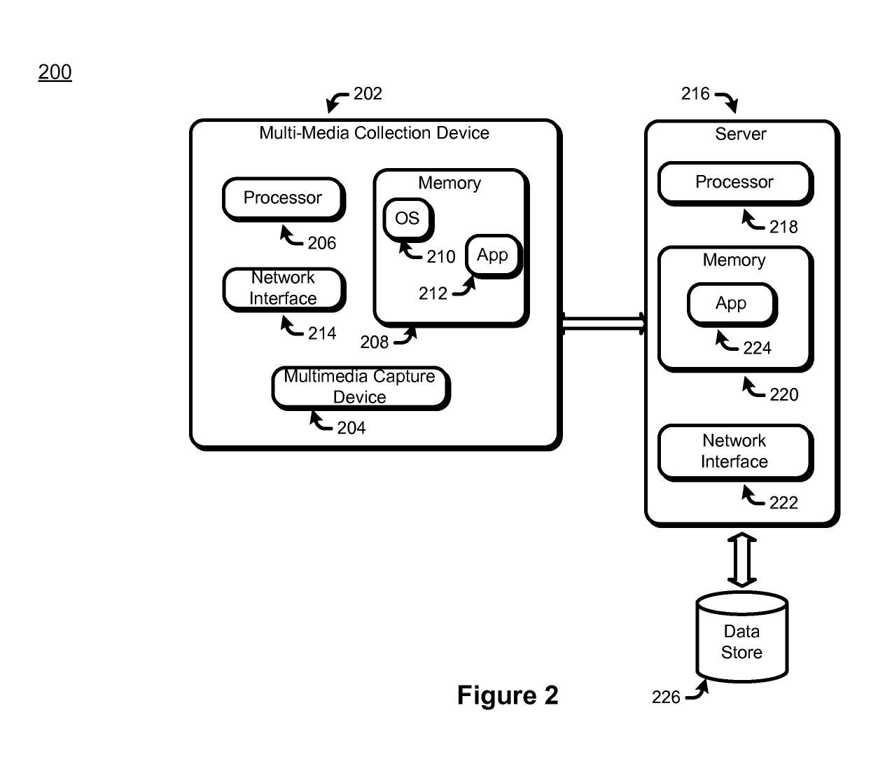

Multi-media collection device 102 is communicatively connected to a server via a network. Example embodiments of multi-media collection device 102, servers, and networks are described in further detail with respect to FIG. 2.

A server may host various modules starting with a workflow processing module 110. Workflow processing module 110 comprises various sub-modules to perform operations on multi-media files.

One exemplary module is a file receiving module 112 which interfaces with multi-media collection device 102 to receive files in a secure fashion. File receiving module 112 may receive file transfers, file moves, file copies, file duplications, file de-duplications, file re-duplications and other file operations for example over File Transfer Protocol (FTP), WebDAV, or other protocols. File receiving module 112 may also be configured both upload and download enabling bidirectional file transfer. File receiving module 112 may operate substantively in real time, either polling every few seconds in a pull architecture, or waiting of upload notifications in a push architecture. File receiving module 112 may validate incoming files, receive associated metadata, receive secure signatures associated with uploading multi-media files from physical media, and may delete files from physical media upon successful upload. File receiving module 112 may integrate with other systems such as a police case management system. For example, when a multi-media file is received, file receiving module 112 may request a case identifier from the police case management system and stored the case identifier with the multi-media file. In this way a multi-media file would be guaranteed to be associated with a case, and made more easily discoverable to any investigator of that case.

Exemplary transcoding module 114 may translate a received file's format to another file's format. Transcoding may also be known as file conversion, refactoring and format recopy. For example, if a law enforcement installation has standardized on H.264 for video files, transcoding module 114 may transform incoming files in AVI format to H.264.

Exemplary file identifier generator 116 may be used to generate a file identifier guaranteed to be unique. For example, file identifier generator 116 may use a globally unique identifier (“GUID”) generator or RPC universal unique identifier (“UUID”) generator to guarantee uniqueness. Alternatively, the file identifier generator 116 may be an autopopulating index value in a relational database.

Exemplary message digest generator 118 may be used to create a message digest of an uploaded multi-media file using MD5 or some other known algorithm. The message digest may be tied to a case identifier and/or a key associated with a user's logon identifier. In this way, a message digest may be generated only by a user associated with a case and privileged to access the multi-media file.

Many other sub-modules may reside in the workflow processing module 110. In general, any operation that may be performed on a multi-media file, be it to add data to the file, associate data/metadata to the file, delete data in the file, edit the file, transform the file, transcode the file, and the like may be performed by a sub-module. There may be sub-modules with redundant functionality.

For example, there may be a second file receiving module 112 designed to guarantee upload of an H.264 file. In one embodiment, multi-media collection device 102 sends an H.264 cyclic redundancy check value in a transmission separate from the file itself. In this way, if the cyclic redundancy check value is truncated during transmission, the redundant cyclic check value from the separate transmission may be used to perform some limited processing of the file.

Yet another file receiving module 112 may be manage receipt of multi-media files via physical storage. For example, in some cases, a multi-media collection device 102 is not able to connect to a server via the network. A memory stick or other physical storage may be proferred by an officer. The proferring officer certifies the storage by signing a form attesting that the officer captured the multi-media file and did modified neither the file nor the physical storage, thereby providing a certified physical storage. In other cases, physical storage may arrive via a certified third party such as United Parcel Service™ or FedEx™. The receiving police officer may perform a manual upload via file receiving module 112, which in turn displays a form where the receiving officer may electronically sign the received file in a secure fashion under a login name or other cryptographically protected identifier.

Yet other alternative embodiments of the file receiving module and other modules are also contemplated.

After processing, the received multi-media files are stored in central data store 120. Central data storage may be a network aware storage, or alternatively a hard drive on a server. Hardware is discussed in more detail with respect to FIG. 2. Central data storage 120 provides a convenience location to search, retrieve, and otherwise share multi-media files and other data/metadata.

Operation in the workflow processing module 110 and data store 120 may be transacted via transaction monitor 122. Distributed transactions may be effected by a transaction monitor such as Microsoft Transaction Server™. Alternatively, transactions may be enabled by transacted stored procedure calls in a relational database such as Microsoft SQL Server™ which enables stored procedures to perform transacted non-database calls, such as to modules within the workflow processing module 110.

A law enforcement installation may have a high volume of multi-media files being uploaded. For example, if fifty officers come in from shift, roughly at the same time, there are potentially at least fifty large files being uploaded. Since multi-media files, in particular video files, are large, there is a risk of the network and processing being congested or otherwise slowed down. Workflow map display 124 is a module that is communicatively connected to workflow processing module 110. Workflow map display 124 may obtain file processing status from workflow processing module 110, and in general may retrieve multi-media file upload counts and other counts of operations performed by the various sub-module and sub-module instances. Workflow map display 124 may display on a computer screen or other display icons representing sub-modules or sub-module instances connected by lines or arrows showing sequences of operations by sub-modules constituting workflow on one or more files. Workflow map display 124 may detect that processing volume is below a predetermined threshold, or has stopped and may provide an indication of congestion. Examples are to flash the icon corresponding to processing stoppage or congestion or provide color coded alerts. In this way, an administrator may determine where processing delays and failures are occurring and respond appropriately.

Workflow map display 124 may also show on a map of an installation the locations of various servers and network devices along with instances of sub-modules. In this way, the physical locations of failures may also be indicated on workflow map display 124.

An alternative to workflow map display 124 is reporting module 126 which may provide text reports. For example, network congestion and processing failures may be provided by reporting module 126 in text based reports. Reporting module may display dialog boxes to select reports and/or multi-media file sources such as a multi-media collection devices. Alternatively, reporting module may display dialog boxes to select specific multi-media files being processed. Based on selections, file location status, file transcoding status, file corruption status and other status may be reported. For example, reporting module 126 is able to indicate that a file came from squad car 9, is 90% complete transcoding, and that a prior effort to upload the file failed. Thus not only may processing failures be determined as a workflow process failure per the workflow map display 124, failures on a per file basis may be determined via the reporting module 126.

Beyond the analysis of individual files per reporting module 126, statistical, aggregate, and historical data may be provided by statistics module 128. Statistics module 128 retrieves instances of multi-media files being uploaded and processed and can calculate maxima, minima, averages, and other statistical values on the data. Accordingly, statistics module 128 may report spikes in reporting, for example that squad car 9 provides four times as much data as the other squad cards, or that three times as many files were processed in March as compared to February.

### Exemplary Hardware Platform

FIG. 2 illustrates one possible embodiment of a hardware environment 200 for multi-media file upload workflow and transactions.

Multi-media collection device 202 is any device that can capture multi-media and persist it as a multi-media file. Multi-media collection device 202 may be conceptualized as multi-media capture device 204, a computing device and a storage. Sometimes the computing device and the multi-media capture device 204 are combined in the same device, such as in a smartphone. Alternatively, the computing device and the multi-media capture device 204 are separate devices such as a digital video camera feeding in to a laptop. Regardless of the configuration, a multi-media captured device 204 may include a digital video camera, a digital still camera, and/or a digital audio recorder.

The computing portion of a multi-media collection device 202 includes at least a processor 206, and a memory 208. Client device 202's memory 206 is any computer-readable media which may store several programs including an operating system 210 and/or an application 212. Memory 208 may also store persisted multi-media files as well. Memory 208 may be removable, such as with thumb drives and/or memory sticks.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

To participate in a communications environment may have a network interface 214. Network interface may be wireless, such as via Wi-Fi or may be wired, such as via Ethernet. Network interface may be cellular hosted on a cell phone infrastructure. Via network interface 214, multi-media collection device 202 may communicate with server 216. For law enforcement purposes, typically the network is a secure wireless network, such as Wi-Fi using WPA2 or AES encryption. In this embodiment, the mobile collection devices are mobile devices with Wi-Fi capability.

Server 216 is any computing device that may participate in a network and fulfill responses to service requests. Server 216 comprises processor 218, memory 220 and network interface 222. As per the preceding discussion regarding user equipment device 202, memory 222 is any computer-readable media including both computer storage media and communication media.

In particular, memory 222 stores software which may include an operating system and/or an application 224. Application 224 may include one or more of the workflow processing module 110, transaction monitor 122, workflow map display 124, reporting module 126 and/or statistics module 128. Memory 222 may also store applications 224 that may include a database management system. Accordingly, server 224 may include data store 226. Data store 226 may be configured as a relational database, an object-oriented database, and/or a columnar database, or any configuration to support policy storage.

### Transacting File Upload Workflow

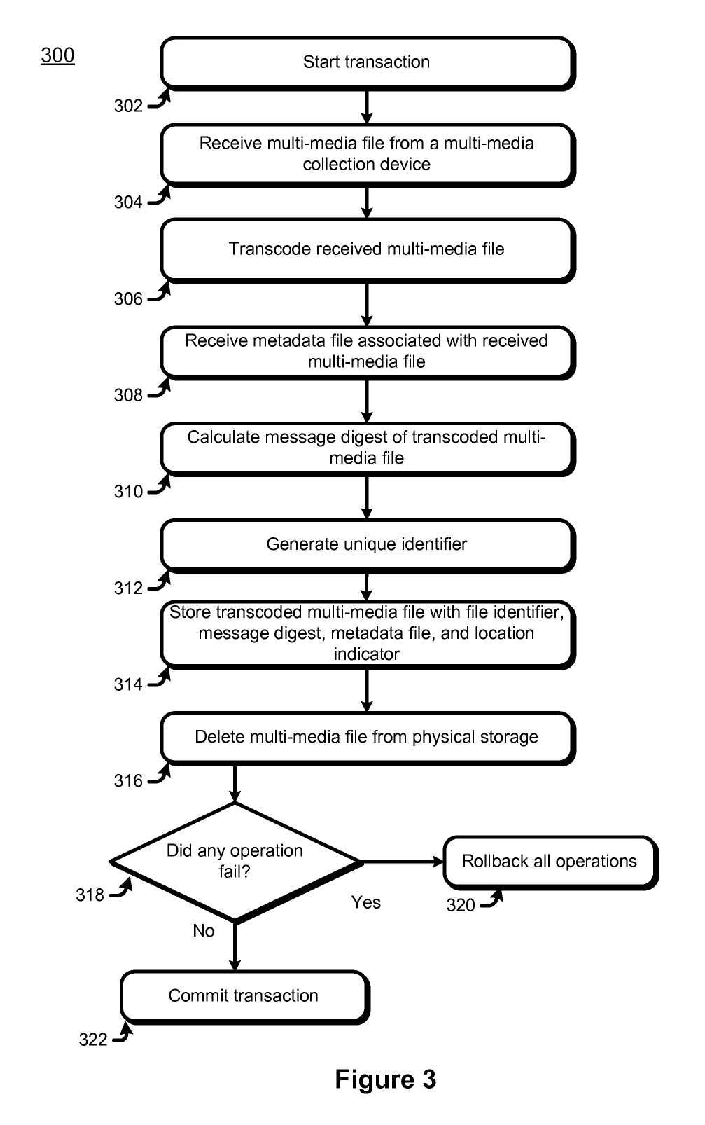

FIG. 3 illustrates an example operation 300 to transact file upload workflow. Specifically, FIG. 3 illustrates a multi-media file upload operation within the context of a transaction.

In block 302 a transaction is initiated. This is typically achieved programmatically in which a transaction monitor is signaled that a set of subsequent operations are to be within the context of a transaction.

In block 304, a module on a server, such as a file receiving module, receives a multi-media file. The file may come directly from a multi-media device over a network or may be from physical storage such as a thumb drive or memory stick.

In some situations, the file received in block 304 may be of a different file format than a law enforcement installation wishes to use. In block 306, a modules, such as a transcoding module converts the received file's format to a predetermined standard format. In this way, transcoding is performed centrally at the server. In other embodiments, the transcoding might be performed on the multi-media collection device, obviating the need to perform transcoding on the server. In this way, transcoding may be distributed, relieving server load by utilizing the processing power of the multi-media devices. Furthermore, if the transcoding is to provide file compression, network load may also be relieved. Note that where transcoding is performed apart from the server, the transcoding operation will not be part of the transaction monitor's transaction context.

In addition to receiving a multi-media file, the file receiving module may receive metadata. In block 308, the file receiving module receives a metadata file. In some cases, the metadata may be embedded with the multi-media file. Typically embedded multi-media data includes the date/time stamp of when the multi-media file was captured and geolocation data. Separate metadata may include commentary and report notes provided by the officer who captured the multi-media file.

In block 310, a message digest value of the multi-media file, the metadata file, or both are calculated. This message digest value is calculated by a message digest generator. The message digest value is used to determine whether the multi-media file, the metadata file, or both have been subsequently tampered with.

In block 312, the multi-media file is provided a unique identifier by a file identifier generator. The identifier may be unique to the system, or may be globally unique. In the case of globally unique identifiers, a multi-media file would then be uniquely identified across systems. In contrast, system unique identifiers run the risk of having a duplicate identifier on another installation.

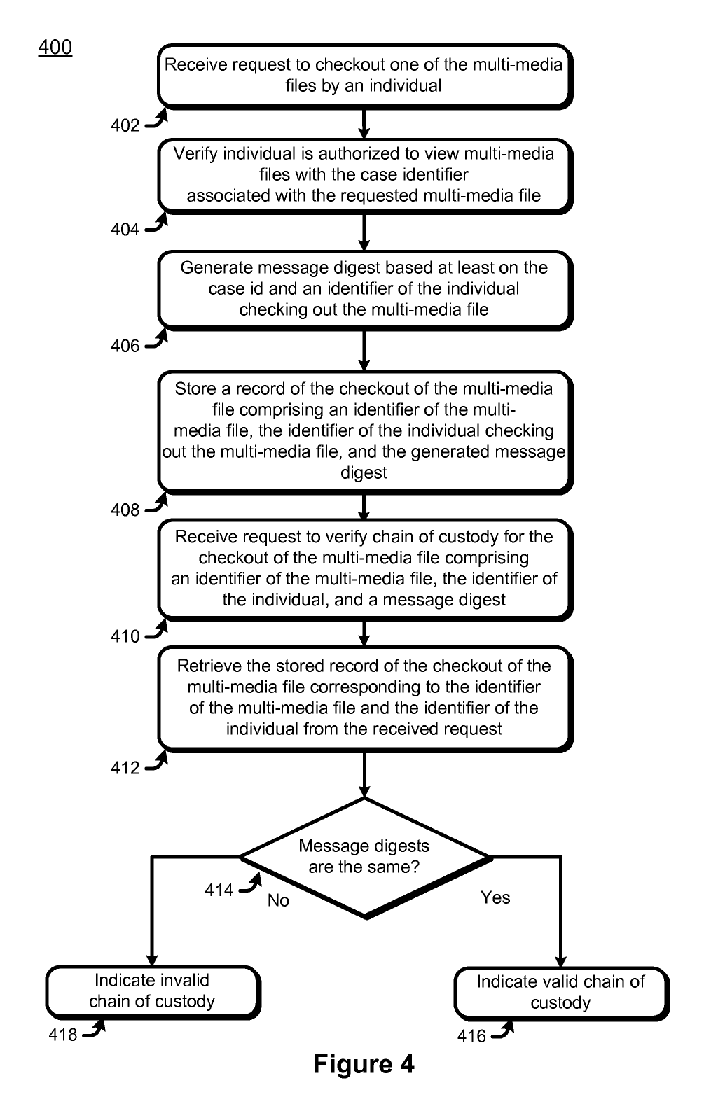

In block 314, the multi-media file is persisted in a data store. It may be persisted with one or more of a file identifier, message digest, metadata file, and a location identifier. In the case of the latter, a location identifier identifies which person, be it prosecutor, attorney, officer, or other law enforcement agent, is responsible for the file. Location identifier may be used for chain of custody applications. Chain of custody is described in more detail with respect to FIG. 4.

In block 316, upon successful uploading, processing and storage of a multi-media file, the multi-media file may be deleted from the physical storage of the multi-media collection device. Not only does this save space on the multi-media collection device, it reduces the chances that the same file may be uploaded redundantly.

After block 316, the transaction completes. As with starting a transaction, ending a transaction is typically done programmatically by invoking a call on the transaction monitor. At this point, the transaction monitor determines whether one of the constituent operations 304, 306, 308, 310, 312, or 314 failed. Failure may be a software failure, timeout due to network congestion, or any number of other causes. If a failure is detected by the transaction monitor 318, then all operations of the constituent operations 304, 306, 308, 310, 312, and 314 are rolled back. In other words, all the operations are undone. In this way, all the constituent operations either all complete or all fail. For example operation 316 which deletes the source file will be undone if the storage operation 314 fails, thereby guaranteeing consistency.

If all operations succeeded, then the transaction monitor commits the transaction in block 322. In other words, the constituent operations 304, 306, 308, 310, 312, and 314 are finalized, will not be undone, and are marked as complete.

### Example Multi-Media File Chain of Custody Validation

The file upload techniques utilizing transactions and message digests can provide a platform for various use cases. FIG. 4 illustrates the operation 400 of an example multi-media file chain of custody validation scenario using these techniques. Chain of custody is a also known as chain of security, chain of confidentiality.

In block 402, a prosecutor or defense attorney decides to analyze one of the multi-media files. Since the attorney may choose to use the multi-media file as evidence, chain of custody is to be enforced.

The attorney checking out the file may first be validated in block 404. Specifically, the attorney may be given privileges to multi-media files associated with a particular case identifier from a police case management system. If the attorney has privileged, the attorney will be allowed to check out the multi-media file.

When the attorney checks out the multi-media file, in block 406 a message digest is generated for the file. The message digest algorithm will use a key associated with attorney, typically a user identifier, or key lookup based on the user password. Also, the message digest algorithm, may make use of the case identifier. In this way, the generated message digest is specific to the user checking out the file and the case identifier. Thus if an attorney is working on multiple cases, and the same file is referenced in those cases, the message digest will be unique if the same file is checked out in each of those cases.

Once the message digest is generated, in block 408 a user identifier, the multi-media file identifier, and the generated message digest are stored. Additional data, such as the date/time stamp of the time the multi-media file was checked out may also be stored.

Later, if the attorney desires to use the checked out multi-media file as evidence, another party may seek to verify that the attorney had not modified the file. In this event, in block 410, the challenging party will provide the identifier of the multi-media file, the identifier of the individual checking out the multi-media file, potentially other information such as the case identifier and the date/time stamp of when the multi-media file was checked out.

In block 412, the original message digest is retrieved for comparison. In block 414, the message digests are compared. If they are the same, then in block 416 an indicator that the chain of custody has been validated may be provided. For example, if the comparison is being done on a computer utility, the utility may display a validating dialog box, and may print out a document for use in court.

If the message digests are not the same, then it is likely that the file was modified after checkout, and in block 418, an indicator that the chain of custody has not been validated may be provided.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-executable method to automate multi-media data collection from multi-media collection devices ensuring chain of custody, comprising:
receiving a multi-media file from a multi-media collection device;
calculating a message digest of the multi-media file;
generating a unique file identifier; and
storing the multi-media file and message digest with a location indicator and the unique identifier, wherein the message digest calculating, file identifier generating, and multi-media file storing are constituent actions in a transaction such that if any of the constituent actions fail, all of the constituent actions are rolled back.

2. The method of claim 1, further comprising receiving a case identifier and wherein the storing further comprises storing the received case identifier with the multi-media file.

3. The method of claim 1, further comprising receiving a metadata file associated with the received multi-media file and wherein the storing further comprises storing the received metadata file with the multi-media file.

4. The method of claim 1 wherein the receiving via upload is via a secure wireless network.

5. The method of claim 1, wherein the receiving comprises:
receiving a certified physical storage media containing the multi-media file;
uploading the multi-media file from the certified physical storage; and
receiving a secure signature of an individual responsible for the uploading the multi-media file from the certified physical storage, wherein the storing further comprises storing the received secure signature with the multi-media file.

6. The method of claim 5, wherein the receiving a certified physical storage media is from a non-law enforcement commercial carrier.

7. The method of claim 5, wherein the uploading further comprises deleting the multi-media file from the certified physical storage upon confirming the successful upload of the multi-media file.

8. The method of claim 1, further comprising: transcoding the received multi-media file to a pre-determined file format, wherein the calculating the message digest is of the transcoded multi-media file and the storing the received metadata file is the storing of the transcoded multi-media file, and the transcoding is a constituent action of the transaction.

9. The method of claim 8, wherein the transcoding is performed on a centralized server.

10. The method of claim 8, wherein the transcoding is performed at the multi-media collection device.

11. A system to track the receiving of multi-media files from a plurality of multi-media collection devices comprising:
a processor;
a memory coupled to the processor;
a storage containing a plurality of multi-media files;
a transaction monitor;
a workflow processing module resident in the memory comprising a plurality of processing modules to perform a plurality of respective operations on at least one of the plurality of multi-media files, wherein at least two of the processing modules are coupled to the transaction monitor such that if at least one of the processing modules fail to operate, all of the operations of the processing modules coupled to the transaction monitor are rolled back; and
a workflow map display module resident in the memory and coupled to the workflow processing module, operable to display the progress of at least one processing module operating on at least one of the plurality of multi-media files.

12. The system of claim 11, wherein the processing modules include a multi-media file receiving module, a transcoding module, a file identifier generator, and a message digest generator.

13. The system of claim 11, further comprising a statistics module resident in the memory coupled to the workflow processing module, the statistics module configured to calculate at least one historical statistic on at least some of the plurality of multi-media files.

14. The system of claim 11, wherein the workflow map display module graphically represents at least some of the processing modules as icons in a workflow diagram and processing flow between at least some of the processing modules as lines.

15. The system of claim 14, wherein the workflow map display module is configured to update substantially in real-time, and to indicate processing modules whose volume of operations are less than a predetermined threshold.

16. The system of claim 11, further comprising a reporting module resident in the memory coupled to the workflow processing module, the reporting module configured to report processing status on the plurality of multi-media files.

17. The system of claim 16, wherein the reporting module reports any one of:
multi-media file location status;
multi-media file transcoding status;
multi-media file corruption; and
statistics on multi-media files.

18. A computer-executable method to automate sharing a multi-media data collection from multi-media collection devices ensuring chain of custody, comprising:
storing a plurality of multi-media files and a plurality of respective case identifiers;
receiving a request to checkout one of the multi-media files by an individual;
verifying that the individual is authorized to view multi-media files with the case identifier associated with the requested multi-media file;
generating a message digest based at least on the case id and an identifier of the individual checking out the multi-media file; and
storing a record of the checkout of the multi-media file comprising an identifier of the multi-media file, the identifier of the individual checking out the multi-media file, and the generated message digest.

19. The method of claim 18, wherein the generating the message digest is based on a date/time stamp of the time of checkout, and the record of the checkout of the multi-media file further comprises the date/time stamp of the time of checkout.

20. The method of claim 18, further comprising:
receiving a request to verify chain of custody for the checkout of the multi-media file comprising an identifier of the multi-media file, the identifier of the individual, and a message digest;
retrieving the stored record of the checkout of the multi-media file corresponding to the identifier of the multi-media file and the identifier of the individual from the received request;
comparing the message digest in the received request with the message digest in the retrieved stored record; and
indicating the chain of custody as validated when the comparison indicates the two message digests are the same.
